(19) United States
(12) Patent Application Publication
(10) Pub. No.: US 2010/0247485 A1
(43) Pub. Date: Sep. 30, 2010

(54) FORMULATIONS AND DEVICES FOR DELIVERING COMPOUNDS TO ARTHROPODS AND MICROORGANISMS WITHIN ARTHOPODS

(75) Inventor: Thomas Kollars, Statesboro, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: MEVLABS, INC., Statesboro, GA (US)

(21) Appl. No.: 12/677,019

(22) PCT Filed: Sep. 5, 2008
(86) PCT No.: PCT/US08/75324

§ 371 Date: May 25, 2010

Related U.S. Application Data
(60) Provisional application No. 60/970,552, filed on Sep. 7, 2007.

(51) Int. Cl. A01N 63/02; A01N 43/42; A01N 43/32; A01N 35/04; A01N 41/06; A01N 63/00; A01P 1/00; A01P 7/00

(52) U.S. Cl. 424/85.4; 514/307; 514/311; 514/292; 514/452; 514/680; 514/601; 424/141.1; 424/93.6

(57) ABSTRACT

Described herein are formulations and devices for delivering compounds to arthropods and microorganisms within the arthropods. The formulations are generally composed of a sugar and the compound, wherein the compound targets a particular pathogen or other microorganism within the arthropod, kills the arthropod, or a combination thereof.

### CROSS REFERENCE TO RELATED APPLICATIONS

This application claims priority upon U.S. provisional application Ser. No. 60/970,552, filed Sep. 7, 2007. This application is hereby incorporated by reference in its entirety for all of its teachings.

### BACKGROUND

Malaria is a major threat to human health and economic development and has killed more humans than all wars combined. Malaria currently infects over 100 million people worldwide and kills millions of people every year, mostly children. There are two principal methods of controlling malaria: drug treatment of patients and the application of pesticides. Both methods, however, are becoming less effective. An increase in drug resistance of the parasite is of great concern to public health officials. Dengue is another mosquito-borne disease that is a major threat to the health of people in Asia, especially children. Adding to the difficulty in controlling malaria and dengue is the emergence of multiple pesticide resistance in many of the Anopheles and Aedes mosquito species that transmit malaria and dengue, respectively. Experimental vaccines hold some promise for the future but no vaccines are currently available for wide dissemination and prevention. Mosquito-borne disease control programs in many nations often face reduction in funding due to money being shifted to prevention and treatment of other diseases. Thus, what is needed is a new approach that addresses these problems.

### SUMMARY

Described herein are formulations and devices for delivering compounds to arthropods and microorganisms within the arthropods. The formulations are generally composed of a sugar and the compound, wherein the compound targets a particular pathogen or other microorganism within the arthropod, kills the arthropod, or a combination thereof. The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF DRAWINGS

FIG. 1 shows a cross-sectional view of a delivery device described herein.

FIG. 2 shows the front view of a delivery device described herein.

FIG. 3 shows the anterior side of a housing useful in the devices described herein.

FIG. 4 shows the anterior side of a housing useful in the devices described herein, wherein a mesh has been inserted in the aperture of the housing from the posterior side.

FIG. 5 shows the anterior side of a housing useful in the devices described herein, wherein a mesh has been inserted in the aperture of the housing from the posterior side.

FIG. 6 shows the posterior side of a housing useful in the devices described herein, wherein a substrate impregnated with sugar and compound is inserted in the aperture of the housing from the posterior side.

FIG. 7 shows a lid for securing the substrate in the housing from the posterior.

FIG. 8 shows one embodiment of a decal affixed to the anterior side of the housing.

FIG. 9 shows a base stem useful in mounting the device to the ground.

### DETAILED DESCRIPTION

Before the present compounds, compositions, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a surfactant” includes mixtures of two or more such surfactants, and the like.

Described herein are formulations and devices for delivering a variety of different compounds to arthropods. The formulations are generally composed of a sugar and the compound(s) to be delivered to the arthropod. Examples of sugars useful herein include, but are not limited to, monosaccharides, disaccharides, or trisaccharides. In one aspect, the sugar is honey, sucrose, dextrose, or any combination thereof. The use of sugar in the formulation provides numerous advantages. For example, in the case of mosquitoes, female mosquitoes feed ten times more frequently on a sugar source than blood meal and the males feed entirely on sugar sources.

The formulations are generally prepared by admixing the compound of choice with an aqueous solution of sugar. In one aspect, the sugar solution is from 0.01% to 99% by weight of the total formulation. In another aspect, the sugar is a mixture of honey, sucrose, and dextrose. For example, the honey, sucrose, and dextrose can each range from 10% to 50% by weight prior to adding to water to produce the sugar solution. In one aspect, the honey, sucrose, and dextrose are each about 33% by weight of the total sugar component. The concentration of the sugar solution can vary. For example, 1 to 9 g of sugar can be added to 1 mL to 10 mL of water to produce the sugar solution.

In addition to sugar, the formulation can also include other optional components such as, for example, preservatives. An example of a preservative useful herein includes sodium benzoate, acetic acid, ascorbic acid, benzoic acids, carbonates, salts, sulfates, carbonic acid, citric acid, decanoic acid, dodecanoic acid, hexadecanoic acid, humic acid, magnesium compounds, octadecanoic acid, octadecenenoic acid, octadecenoic, octanoic acid, potassium, silicic acid, sulfuric acid salts, tetradecenoic acid, mineral oil, or any combination thereof. Other components such as arthropod attractants (e.g. pheromones) can also be present in the formulations.

The amount of compound used will vary depending upon the compound selected and the intended use of the compound. In one aspect, the amount of pesticide compound in the formulation is from 500 μg to 11,000 μg/mL of 50% by weight sugar solution. In another aspect, the compound is from 10 to 2,000 ITU pesticide per mL of 90% sugar solution.

The selection of the compound to be delivered depends upon the target arthropod, the microorganisms within the arthropod, and the desired result. The formulations and devices can be designed to target a variety of arthropods including, but not limited to, insects (e.g., flies, mosquitoes, fleas, aphids, whiteflies, leafhoppers, and delphacid planthoppers, thrips, chrysomellid beetles), acarines (e.g. eriophyid mites, chigger mites, ticks), and the like.

In one aspect, the compound can target pathogens and other microorganisms within the arthropod upon ingestion of the formulation. For example, the compound can block the activity of a virus or parasite present in a mosquito responsible for malaria transmission. Examples of such compounds include, but are not limited to, quinoline alkaloids, iso-quinoline alkaloids, indoloquinoline alkaloids, carbolines, bisisoquinoline, 4-quinazole derivatives, trioxanes, terpenes, naphthoquinone, anthraquinones, chalcones, hydroxy flavanones, coumarins phenolic glycosides, quininidine, quinine, hydroquinidine, apoquinine, hydroquinine, pamaquine, primaquine, 6-H-8 Am″, 5-H-6, MAm′2, 5-H-Amc:1, DEMP′4, chloroquine, pyrimethamine, artemisinin, halofantrine, atovaquone, s-artelinate, fenozan-50FRC-12, pyronaridine, mepacrine, chloroqume, amodiaquine, mefloquine, WR14997s, halofantrine, tetracycline, minocycline, Quin+Tetra, QST, Primaq+Chlor, Primaq+Quin, Pyrim+Chlor, Pyrim+Sulphad, Pyrim+Sulfadox, Pyrim+Sulfal, Diapheny+Pyrim, CP+DADDS, MSP, Sulfadox+Trim, WR238605f, WR242511, WR2505478, WR25054811, WR238605, WR238605, WR250547, WR250548, floxacrine1′, M22791′, menoctone1′, atovaquone1′, proguanil, chlorproguanil, pyrimethamine, WR 182393′, sulphadiazine, sulphamezathine, sulfalene, dapsonel, sulfadoxine, antibiotics (e.g. doxycycline, tetracycline) or any combination thereof.

In another aspect, the compound inhibits dengue virus replication and other arboviruses, including animal and plant virus, such as West Nile Virus, Japanese encephalitis virus, yellow fever virus, (1) the nonpersistently transmitted, stylet-borne viruses; (2) the semi-persistently transmitted, foregut-borne viruses; (3) the persistently transmitted, circulative viruses; and (4) the persistently transmitted, propagative viruses. Examples of such compounds include, but are not limited to, xanthates, antisense attachment, entry and fusion inhibitors, DNA polymerase inhibitors, integrase inhibitors, interferons, maturation inhibitors, monoclonal antibodies, neuraminidase inhibitors, NS3 protease inhibitors, nucleoside reverse transcriptase inhibitors, nucleotide reverse transcriptase inhibitors, protease inhibitors, reverse transcriptase inhibitors, RNA polymerase inhibitors, and any combination thereof. In one aspect, the compound is mycophenolic acid or ribavirin.

In one aspect, the compound is an anti-parasite such as anti-filaria, anti-leishmania, anti-trypanasomes, anti-loa loa, or anti-onchoceriasis. Examples of anti-parasites useful herein include, but are not limited to, diethylcarbamazine citrate, ivermection, and antibiotics (e.g., doxycyline, tetracycline).

The compounds described above target a particular pathogen or other microorganism within the arthropod. Alternatively, the compound can be a pesticide that kills the arthropod. Using the formulations and devices described herein, the pesticide is delivered directly to the mosquito and not to non-target organisms. Examples of pesticides useful herein include, but are not limited to, any bactererial species (e.g. Bacillus thuringiensis), viruses (e.g. densoviruses), biocontrol pesticides, abamectin, phostoxin/fumitoxin, bifenthrin, carbaryl, chlorfenapyr, beta-cyfluthrin, cypermethrin, deltamethrin, dichlorvos, D-phenothrin, D-trans allethrin, resmethrin, methomyl, hydramethylnon, fenoxycarb, fipronil, imidacloprid, imidacloprid, lambda-cyhalothrin, malathion, methoprene, naled, nithiazine, P-dichlorobenzene, permethrin, permethrin-piperonyl butoxide, propetamphos, propoxur, pyrethrins, phenothrin, allethrin, hydroprene, resmethrin, spinosad, sumthrin, sumthrin-piperonyl butoxide, temephos, mosquito larvicide, pupicide, or any combination thereof.

Although the sugar and compound can be formulated into one composition, it is also contemplated that the sugar solution and compound can be in separate vials or containers that can be subsequently mixed. In one aspect, the solution of sugar is present in a vial, and the compound in dry or neat form alone can be added to the vial of the sugar solution. The use of the formulations is described below.

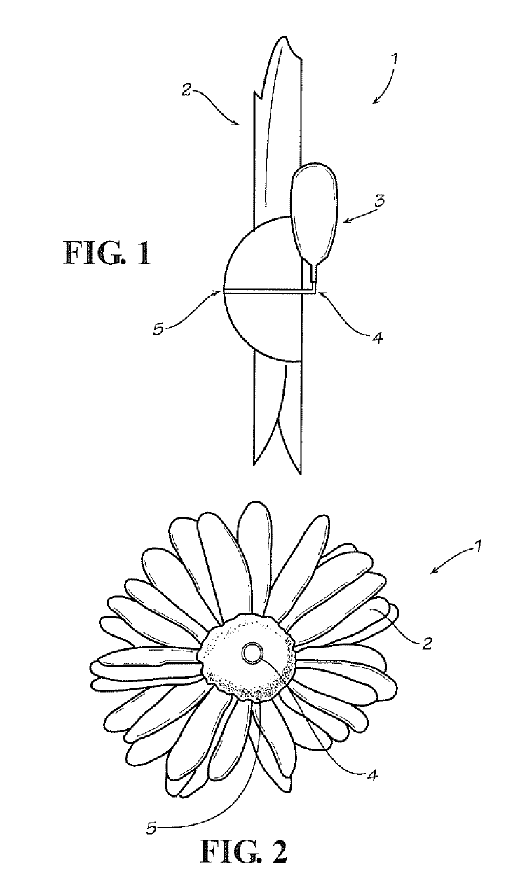

The formulations described herein can be introduced into a device for delivering the formulation to an arthropod. The size, design, and colors of the device can vary depending upon the targeted arthropod. In one aspect, the delivery device 1 depicted in FIGS. 1 and 2 can be used. Referring to FIGS. 1 and 2, the delivery device 1 is a flower. The flower 1 can be a live flower or an artificial flower made from wood, silk, plastic, or other synthetic materials. The formulation is contained within a small bottle, container 3. The container 3 is attached to the backside of the artificial flower 1. A dispensing tube 4 is connected to container 3. The dispensing tube 3 is positioned in the flower 1 so that it is accessible to the arthropod. In this case, the dispensing tube 3 is positioned longitudinally in flower 1. A bee barrier 5 constructed of mesh or filter is fitted to the dispensing tube 3 in a manner such that the target arthropod can ingest the formulation but a non-target species (e.g. a bee) cannot feed on the solution.

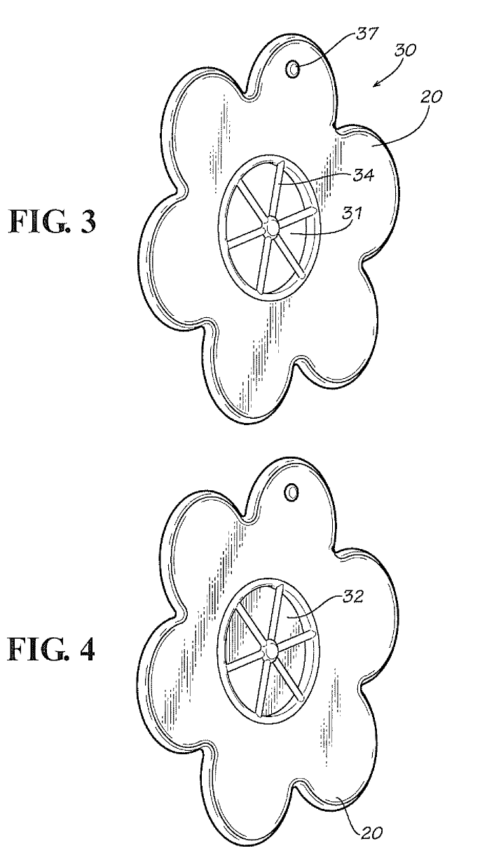

Another embodiment of the delivery device can be found in FIGS. 3-10. FIGS. 3 and 4 show the posterior side 20 and anterior side 25, respectively, of housing 30. The housing 30 is shaped as a flower; however, the housing can be manufactured in any desirable shape and size. The housing is generally composed of any durable material such as, for example, plastic or other materials that can withstand long-term exposure to water, heat, and sunlight. The color of the housing can also vary. In certain aspects, when the device is used to attract mosquitoes, the housing 30 is black.

Referring to FIG. 3, the housing 30 has an aperture 31. Although aperture 31 is located at the center of housing 30, the location of the aperture in the housing can vary. The aperture 31 has several functions with respect to the use of the device. First, referring to FIGS. 4 and 5, a mesh 32 is inserted in the aperture 31 from the posterior side of the housing 30. The diameter of mesh 32 is identical to or very close to the diameter of the aperture 31 to insure that the mesh covers as much of the aperture 31 as possible. The mesh 32 is secured to the housing 32 by techniques known in the art such as, for example, adhesives. For example, an adhesive can be applied to grids 34 facing the posterior side of the housing followed by adhering mesh 32 to the grids. In this aspect, the mesh 32 is permanently affixed to housing 30. The mesh is selected to permit only certain types of insects access to the substrate (described below). For example, when the mesh has a hole size of 75 to 150 mosquitoes can access the substrate with their proboscis. The material of the mesh 32 can vary from metal to durable woven fibers. The material is generally selected such that it can withstand long-term exposure to water, heat, and sunlight.

With respect to the formulations described herein (i.e., sugar and compound), they are applied to a substrate, which can ultimately be incorporated into the device. The substrate is generally composed of any material that can retain the sugar and compound as described above. For example, the substrate can be composed of any absorbent paper such that when the formulation is applied to the paper, the sugar and compound are absorbed by the paper. Examples of absorbent paper useful herein include cellulose filter papers 0.2 mm to 2 mm thick. Other suitable absorbent substrates include those made from carbon, rubber, synthetics, plastic and sponge.

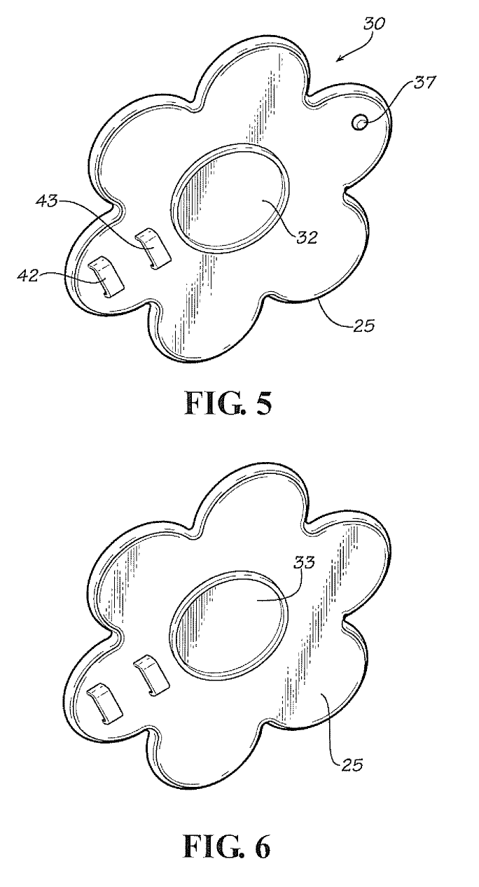

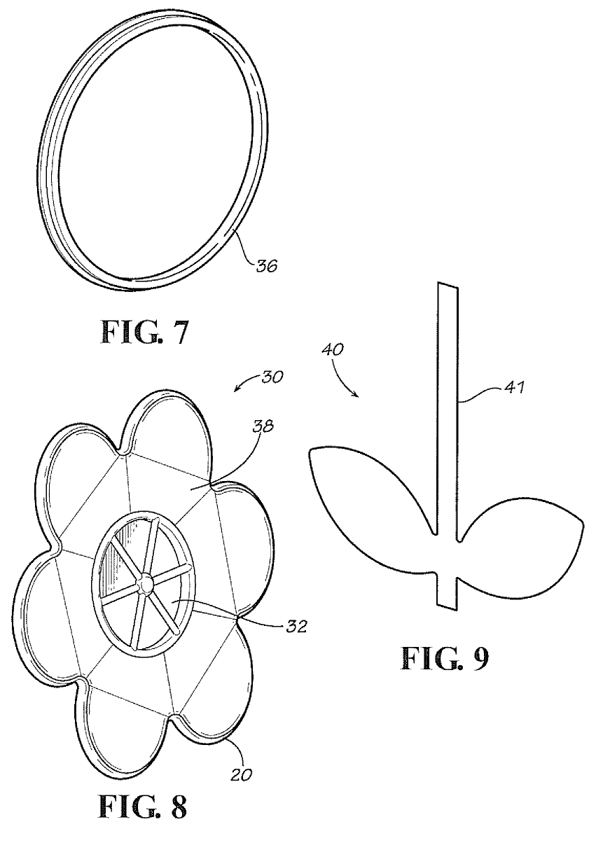

The shape and size of the substrate can vary depending upon how it is to be secured and used in the device. FIG. 6 depicts one aspect for incorporating the substrate in the device. The substrate 33, which can be a round piece of filter paper impregnated with sugar and compound, has been placed below the mesh 32 in FIG. 5 through the aperture located at the posterior of the device. In this aspect, the substrate is a replaceable component. Thus, once all of the sugar and/or compound have been consumed, a new substrate 33 can be inserted in aperture 31 and placed on mesh 32. The substrate 33 can be held in place by the addition of a lid 36 (FIG. 7) placed over or within lip 35 on housing 30.

The device can have additional features that enhance the performance of the device. In one aspect, a decal having one or more different colors can be placed over aperture 31 to attract certain types of insects. Colors have been found to be an important attractant to a number of arthropods. For example, colors ranging from 350 to 700 nm, black and white have attractancies to different species of mosquitoes. Anopheles mosquitoes were more attracted to black and red than to other colors. Aedes species were attracted to black, blue and red. Referring to FIG. 8, the decal 38 is placed around aperture 31 on the anterior side 25 of housing 30. The decal can be adhered to the anterior side of housing 30 using conventional adhesives.

The device described herein can be used in a number of different applications and environments. In certain aspects, it is desirable to hang the device. In this aspect, the housing 30 can be equipped with one or more hooks to hang the device. In other aspects, the housing can have a hole (37 in FIGS. 3 and 5) to receive a hanging hook. In other aspects, the device can be mounted to the ground. For example, the housing 30 can receive a base stem 40 (FIG. 9), which can be driven into the ground. In this aspect, stem 41 of base stem 40 can be inserted into clips 42 and 43 (FIG. 5) and secured to the posterior side 25 of housing 30.

Referring to FIG. 8 as an example, a summary of the use of the device for delivering a compound to arthropod is provided. An arthropod such as a mosquito approaches the anterior side 20 of housing 30. The mosquito is attracted to device by the presence of chemical cues from the formulation and/or one or more colors present on the decal 38. When the mosquito reaches the device, it inserts its proboscis into mesh 32, penetrates the mesh, and contacts the substrate 33 impregnated with the sugar and compound. In the case of mosquitoes, they are attracted to the substrate by the sugar. The mosquito ingests the sugar and compound, and the compound is subsequently delivered internally to the mosquito. Once the sugar and/or compound have been depleted from the substrate 33, a new substrate 33 can be inserted into the device as described above.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The estimated ED 50 of Ribavirin, anti-viral drug, was not lethal to Aedes and Anopheles mosquitoe species at 70 μg/ml. Other non-lethal concentrations ranged from 1 to 150 ug/ml. The estimated ED 50 of Pyremethamine, anti-malarial drug, was not lethal to Anopheles at 7 μg/ml. Other non-lethal concentrations range from 3 ng/mL to 1 mg/ml.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed:

1. A device for delivering a compound to an arthropod or microorganism within the arthropod, the device comprising a substrate incorporated within the device, and the substrate comprises a sugar and the compound, wherein the compound targets a particular pathogen or other microorganism within the arthropod, kills the arthropod, or a combination thereof.

2. The device of claim 1, wherein the sugar comprises a monosaccharide, disaccharide, trisaccharide, or honey.

3. The device of claim 1, wherein the sugar comprises a mixture of honey, sucrose, and dextrose.

4. The device of claim 1, wherein the compound can block the activity of a virus or parasite present in a mosquito responsible for malaria transmission.

5. The device of claim 4, wherein the compound comprises quinoline alkaloids, iso-quinoline alkaloids, indoloquinoline alkaloids, carbolines, bisisoquinoline, 4-quinazole derivatives, trioxanes, terpenes, naphthoquinone, anthraquinones, chalcones, hydroxy flavanones, coumarins phenolic glycosides, quininidine, quinine, hydroquinidine, apoquinine, hydroquinine, pamaquine, primaquine, 6-H-8 Am″, 5-H-6, MAm′2, 5-H-Amc:1, DEMP′4, chloroquine, artemisinin, halofantrine, atovaquone, s-artelinate, fenozan-50FRC-12, pyronaridine, mepacrine, chloroqume, amodiaquine, mefloquine, WR14997s, halofantrine, tetracycline, minocycline, Quin+Tetra, QST, Primaq+Chlor, Primaq+Quin, Pyrim+Chlor, Pyrim+Sulphad, Pyrim+Sulfadox, Pyrim+Sulfal, Diapheny+Pyrim, CP+DADDS, MSP, Sulfadox+Trim, WR238605f, WR242511, WR2505478, WR25054811, WR238605, WR238605, WR250547, WR250548, floxacrine1′, M22791′, menoctone1′, atovaquone1′, proguanil, chlorproguanil, pyrimethamine, WR 182393′, sulphadiazine, sulphamezathine, sulfalene, dapsonel, sulfadoxine, antibiotics or any combination thereof.

6. The device of claim 1, wherein the compound inhibits dengue virus replication in a mosquito.

7. The device of claim 6, wherein the compound comprises xanthates, antisense attachment, entry and fusion inhibitors, DNA polymerase inhibitors, integrase inhibitors, interferons, maturation inhibitors, monoclonal antibodies, neuraminidase inhibitors, NS3 protease inhibitors, nucleoside reverse transcriptase inhibitors, nucleotide reverse transcriptase inhibitors, mycophenolic acid, ribavirin, or any combination thereof.

8. The device of claim 1, wherein the compound comprises an anti-parasite, anti-leishmania, anti-trypanasomes, anti-loa loa, or anti-onchoceriasis.

9. The device of claim 8, wherein the compound comprises an anti-parasite, wherein the anti-parasite comprises diethylcarbamazine citrate, ivermection, doxycyline, or tetracycline.

10. The device of claim 1, wherein the compound comprises a pesticide.

11. The device of claim 10, wherein the pesticide comprises Bacillus thuringiensis, a densovirus, a biocontrol pesticide, abamectin, phostoxin/fumitoxin, bifenthrin, carbaryl, chlorfenapyr, beta-cyfluthrin, cypermethrin, deltamethrin, dichlorvos, D-phenothrin, D-trans allethrin, resmethrin, methomyl, hydramethylnon, fenoxycarb, fipronil, imidacloprid, imidacloprid, lambda-cyhalothrin, malathion, methoprene, naled, nithiazine, P-dichlorobenzene, permethrin, permethrin-piperonyl butoxide, propetamphos, propoxur, pyrethrins, phenothrin, allethrin, hydroprene, resmethrin, spinosad, sumthrin, sumthrin-piperonyl butoxide, temephos, mosquito larvicide, pupicide, or any combination thereof.

12. The device of claim 1, wherein substrate comprises an absorbent paper.

13. The device of claim 1, wherein the device comprises a housing having an anterior side and posterior side and an aperture for receiving the substrate on the posterior side and providing access to the substrate by the arthropod at the anterior side, (2) a mesh attached to the housing and covering the aperture, and (3) the substrate, wherein the substrate is adjacent to or in close proximity to the mesh on the posterior side of the housing.

14. The device of claim 13, wherein the housing is the shape of a flower.

15. The device of claim 1, wherein the housing further comprises a hook or hole for hanging the device.

16. The device of claim 1, wherein the device further comprises a base stem attached to the housing for mounting the device to the ground.

17. The device of claim 13, wherein the device further comprises a decal comprising one or more colors, wherein the decal is attached to the posterior side of the housing and covers a portion of the aperture such that the arthropod has access to the substrate.

18. The device of claim 1, wherein the sugar comprises an aqueous mixture of honey, sucrose, and dextrose.

19. A composition for delivering a compound to an arthropod or microorganism within the arthropod, the composition comprising a sugar and the compound, wherein the compound targets a particular pathogen or other microorganism within the arthropod, kills the arthropod, or a combination thereof, wherein the compound is not bacteria.

20. The composition of claim 19, wherein the sugar comprises a monosaccharide, disaccharide, trisaccharide, or honey.

21. The composition of claim 19, wherein the sugar comprises an aqueous mixture of honey, sucrose, and dextrose.

22. The composition of claim 19, wherein the compound can block the activity of a virus or parasite present in a mosquito responsible for malaria transmission, wherein the compound comprises quinoline alkaloids, iso-quinoline alkaloids, indoloquinoline alkaloids, carbolines, bisisoquinoline, 4-quinazole derivatives, trioxanes, terpenes, naphthoquinone, anthraquinones, chalcones, hydroxy flavanones, coumarins phenolic glycosides, quininidine, quinine, hydroquinidine, apoquinine, hydroquinine, pamaquine, primaquine, 6-H-8 Am″, 5-H-6, MAm′2, 5-H-Amc:1, DEMP′4, chloroquine, artemisinin, halofantrine, atovaquone, s-artelinate, fenozan-50FRC-12, pyronaridine, mepacrine, chloroqume, amodiaquine, mefloquine, WR14997s, halofantrine, tetracycline, minocycline, Quin+Tetra, QST, Primaq+Chlor, Primaq+Quin, Pyrim+Chlor, Pyrim+Sulphad, Pyrim+Sulfadox, Pyrim+Sulfal, Diapheny+Pyrim, CP+DADDS, MSP, Sulfadox+Trim, WR238605f, WR242511, WR2505478, WR25054811, WR238605, WR238605, WR250547, WR250548, floxacrine1′, M22791′, menoctone1′, atovaquone1′, proguanil, chlorproguanil, pyrimethamine, WR 182393′, sulphadiazine, sulphamezathine, sulfalene, dapsonel, sulfadoxine, antibiotics or any combination thereof.

23. The composition of claim 19, wherein the compound inhibits dengue virus replication in a mosquito, wherein the compound comprises xanthates, antisense attachment, entry and fusion inhibitors, DNA polymerase inhibitors, integrase inhibitors, interferons, maturation inhibitors, monoclonal antibodies, neuraminidase inhibitors, NS3 protease inhibitors, nucleoside reverse transcriptase inhibitors, nucleotide reverse transcriptase inhibitors, mycophenolic acid, ribavirin, or any combination thereof.

24. The composition of claim 19, wherein the compound comprises a pesticide, wherein the pesticide comprises a densovirus, a biocontrol pesticide, abamectin, phostoxin/fumitoxin, bifenthrin, carbaryl, chlorfenapyr, beta-cyfluthrin, cypermethrin, deltamethrin, dichlorvos, D-phenothrin, D-trans allethrin, resmethrin, methomyl, hydramethylnon, fenoxycarb, fipronil, imidacloprid, imidacloprid, lambda-cyhalothrin, malathion, methoprene, naled, nithiazine, P-dichlorobenzene, permethrin, permethrin-piperonyl butoxide, propetamphos, propoxur, pyrethrins, phenothrin, allethrin, hydroprene, resmethrin, spinosad, sumthrin, sumthrin-piperonyl butoxide, temephos, mosquito larvicide, pupicide, or any combination thereof.

25. The composition of claim 19, wherein the compound is from 0.1 to 5 μg of 600 to 2,000 ITU per mL of a solution of the sugar.

26. A kit for delivering a compound to an arthropod or microorganism within the arthropod, the composition comprising a sugar and the compound, wherein the compound targets a particular pathogen or other microorganism within the arthropod, kills the arthropod, or a combination thereof.

27. The kit of claim 26, wherein the kit further comprises a substrate for holding the composition.

28. A substrate for delivering a compound to an arthropod or microorganism within the arthropod, wherein the substrate comprises a sugar and the compound, wherein the compound targets a particular pathogen or other microorganism within the arthropod, kills the arthropod, or a combination thereof.
